(19) United States
(12) Patent Application Publication
(10) Pub. No.: US 2014/0322408 A1
(43) Pub. Date: Oct. 30, 2014

(54) SYSTEM AND METHOD FOR GENERATION OF FOOD ITEMS WITH VISIBLE INDICIA

(71) Applicant: Zeta Function LLC, Chesterland, OH (US)

(72) Inventors: Rajesh Khosla, Gates Mills, OH (US); Kush Chandra Khosla, Gates Mills, OH (US); Sauren Khosla, Gates Mills, OH (US)

(73) Assignee: Zeta Function LLC, Chesterland, OH (US)

(21) Appl. No.: 14/264,433

(22) Filed: Apr. 29, 2014

Related U.S. Application Data
(60) Provisional application No. 61/817,059, filed on Apr. 29, 2013.

(51) Int. Cl. A47J 37/08

(52) U.S. Cl. CPC A47J 37/0892
USPC 426/383; 99/352

(57) ABSTRACT

A method and apparatus for applying images to food items, such as toast, includes a controllable at least one controllable heating elements directed to as to be disposed along a surface of an associated food item. The heating element is controllable along the surface in accordance with stored image data to apply the image to a food item. Image data is receivable from a data device such as a smart phone, tablet or computer either via a direct data connection or via a wide area network such as the Internet. Images are retrievable in accordance with payment or sponsorship.

### TECHNICAL FIELD

The subject application includes embodiments directed generally to providing indicia to foods. The application includes an embodiment particularly directed to providing various indicia, including graphics or text, to flat surface foods, such as bread, waffles, or the like.

### BACKGROUND

Food items are rendered desirable in conjunction with sight, taste, touch and smell. These senses allow one to determine whether a particular food is edible or potentially harmful, and whether it its sufficiently fresh. Food preparation has evolved to include presentation that is primarily for aesthetic purposes. Enhanced presentation can increase the enjoyment associated with eating.

Food presentation can be extremely important with children. Presenting food to children in interesting ways, especially when a food is nutritious but not particularly appealing, can minimize chances of rejection. More recently, foods have been shaped in appealing or novel ways. By way of examples, crackers may be shaped as animals and cookies shaped as windmills.

### BRIEF DESCRIPTION OF THE DRAWINGS

FIG. 1 illustrates an embodiment wherein a toaster is provided with data connectivity and control for application of indicia on food items;

FIG. 2 illustrates an embodiment of a heater element for application of heat to a targeted area of a food item;

FIG. 3 illustrates an embodiment of an array control for heating elements;

FIG. 4 is a flow chart of a suitable control system for use in conjunction with heating elements;

FIG. 5 illustrates an embodiment including audio or visual output indicators;

FIG. 6 illustrates an embodiment including photo members for application of images and an embodiment wherein an image rendering element is changeable or replaceable;

FIG. 7 illustrates an embodiment for networked imaging;

FIG. 8 illustrates further embodiments of a heating element;

FIG. 9 illustrates further embodiments of a heating element;

FIG. 10 illustrates further embodiments of a heating element;

FIG. 11 illustrates further embodiments of a heating element;

FIG. 12 illustrates further embodiments of a heating element;

FIG. 13 is a flow chart for an embodiment of a control routine;

FIG. 14 illustrates an imaging device wherein some or all control circuitry associated with heating or imaging is provided in an attachable module; and

FIG. 15 illustrates an embodiment wherein an image is applicable to one or more sides of a non-food substrate.

### OVERVIEW OF EXAMPLE EMBODIMENTS

In accordance with the subject application, a system and method for providing indicia, including preset or customized indicia is disclosed. The application includes embodiments wherein a graphical, textual or combined graphics and text indicia are applied to foods. The embodiments disclosed below include both heat-based application, wherein cooking induces changes in physical appearance, and printer-based applications, wherein coloration is applied directly to a food.

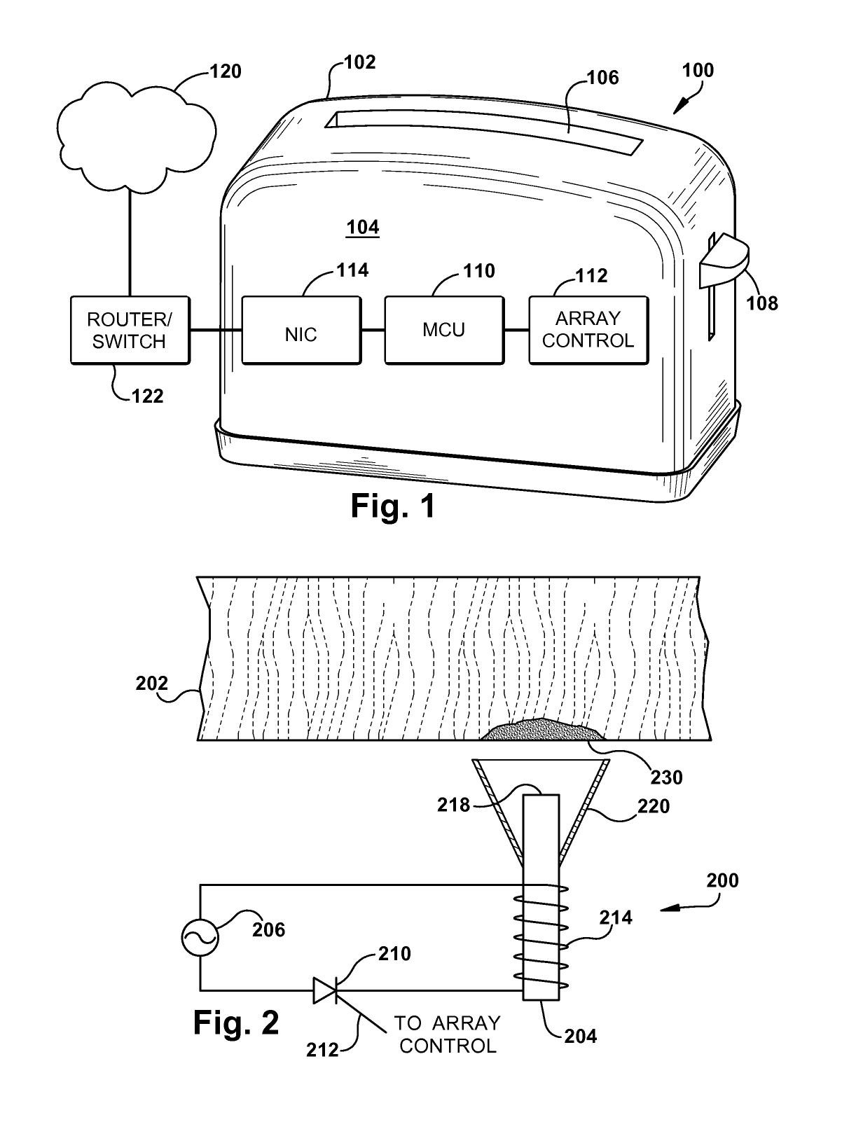

Turning now to FIG. 1, illustrated is an embodiment of an indicia application system 100 that includes a toaster 102. The basic construction and operation of toaster, including a housing 104, one or more food supports operable to receive food, illustrated in conjunction with slot 106, lowering/eject mechanism 108 associated with a food support, etc., are well within the understanding of one of ordinary skill in the art.

Included in the embodiment of FIG. 1 is an associated control and data system to facilitate application of graphical or textual indicia on a food, such as bread, English muffins, or any food stuff having an available presentation surface. Included is a microcomputer unit (MCU) 110, suitably inclusive of at least one processor, memory and operable under software control as will be appreciated by one of ordinary skill in the art. In data communication with the MCU is an array control 112 that directs application of indicia as will be detailed in the embodiments below. Also in data communication with the MCU 110 is a network interface control (NIC) 114. It will be understood by one of ordinary skill in the art that a NIC suitably functions to exchange data to an associated device, via a direct connection or connection to a local area network, wide area network or a large-scale network, such as the Internet. Such connections are suitably wired, as with an Ethernet connection, or wireless such as with Wi-Fi, radio or cellular communication system, as well as any other communication protocol. In the embodiment of FIG. 1, NIC 114 is in data communication with a network 120 via a router or switch 122.

With the system embodied in FIG. 1, it will be understood that array control 112 suitably operates under control of MCU 110 to direct application of heat, light, dye, ink, or other colorant to a food in accordance with communicated, pre-stored or generated graphics or text, or graphics or text data that is communicated to the device, such as via a network connection. By way of example, images are suitably stored as electronic files, such as JPEG, GIF, TIFF, PDF, or any other suitable encoded format, including bitmapped graphics or vector-based graphics. Such images are also suitably obtained by a digital camera, cell phone, or other digital image capturing system. Images are also suitably received from another device via a data connection, such as a wireless, optical or wired link. Data connections are suitably accomplished via a cellular network, Bluetooth, near field communication, USB, piconet, local area network, a wide area network or the Internet, as well as any suitable combination thereof as will be appreciated by one of ordinary skill in the art.

Turning now to FIG. 2, an embodiment of a suitable heating element 200 to provide color change via cooking to a targeted portion of a food, such as bread or other foodstuff 202, is described. It will be appreciated that, in conjunction with the teachings herein, both positive imaging and negative imaging are suitable. That is to say, colorant or heating are suitably applied to the image elements themselves, or to background so as to define foreground elements, or a combination thereof. In the illustrated embodiment, a suitably electrically-heated and thermally transmissive core 204 and heating coil 214 are provided with electrical power via a power source 206. In this embodiment, the power source 206 provides alternating current, although it will be appreciated by one of ordinary skill in the art that direct current is also suitable with complementary control or switching, such as via a mechanical, electromechanical or solid state controlled switch. In the illustrative embodiment of FIG. 2, control is suitably provided by a thyristor at 210. A control lead 212 is suitably associated with array control 112 of FIG. 1. An embodiment of suitable control will be detailed below.

An advantage of an embodiment wherein control is provided by a thyristor and alternating current is that power will be continually provided to the heating element as long as the control lead is suitably powered. If power is toggled on the control lead 212, then a next phase change of the AC current will cause the thyristor to disconnect, and it will remain disconnected until power is again applied to the control lead. Thus, particular heating durations can be controlled very precisely with controlled signals such as that associated with array control 112 under control of MCU 110. Associated with a distal end 218 of core 204 is a thermally insulative cowling 220 that directs heat to a target area 230 of bread 202, or other heat-responsive foodstuff. It will be appreciated that when heat is applied to a bread slice, when the bread's surface temperature reaches about 310 degrees Fahrenheit, a chemical change known as the Maillard reaction begins. Sugars and starches start to caramelize or turn brown.

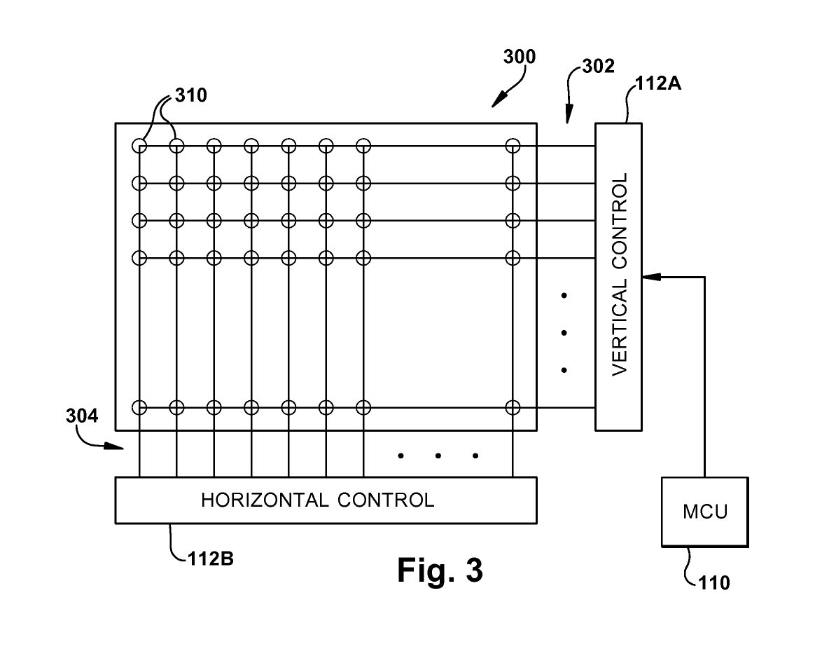

Turning now to FIG. 3, illustrated is an embodiment of a suitable control array 300. Array control 112 of FIG. 1 in the illustrated embodiment is suitably comprised of a vertical control 112A and a horizontal control 1128. Vertical control 112A suitably generates a plurality of vertical control lines 302, while Horizontal control 112B suitably generates a plurality of horizontal control lines 304. Such lines are suitably generated with instruction words, multiplexers, binary output signals, combinational logic, programmable gate arrays, or the like, as will be understood by one of ordinary skill in the art. In the illustrated embodiment, intersection of control lines are associated with plurality nodes 310, which nodes are associated with food cooking or coloration.

The array of FIG. 3 is illustrated as rectangular. It will be appreciated by one of ordinary skill in the art that any suitable array, including circular, staggered or cluster-based array, are suitably implemented in accordance with specific applications. The image processing can be done one of two ways and either on one side or both sides by suitably replicating the representative embodiment of FIG. 3.

It will further be appreciated that the above-described control system is suitably implemented in connection with a heating system, such as that detailed above, or with dye, ink, or food coloring application. Suitable application is realizable with ink jet applicators when used in conjunction with edible or non-toxic colorants. Such electrical deposition systems are suitably controlled in conjunction with the above-described control array system.

In addition to the forgoing, application of substances to the foodstuffs additionally enables application of specific colors or flavors suitably placed overall or on specific points to enhance either or both the image and the flavor.

In yet another embodiment, suitable imaging is accomplished by application of light energy, such as via an array of lasers, such as solid state lasers, or by the use of one or more lasers that are directed to various areas of the food via controlled lensing, mirroring, or the like.

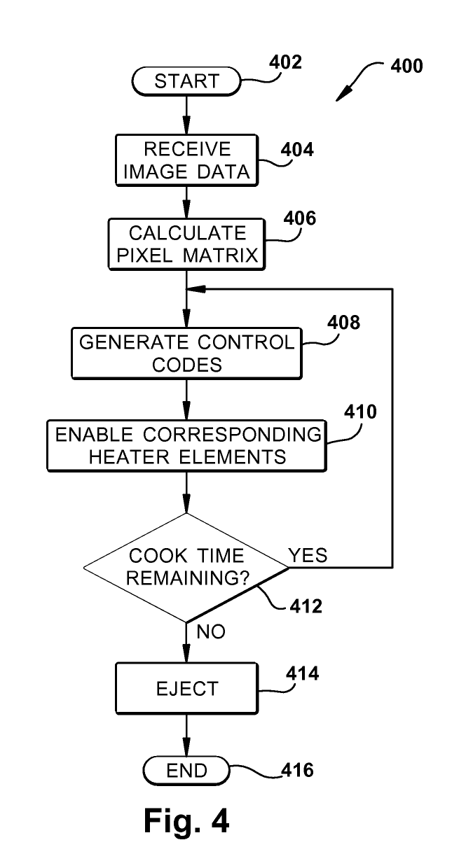

Turning now to FIG. 4, a suitable control algorithm 400 for use in conjunction with the MCU 110 is detailed. The process commences at 402, and proceeds to receive image data at 404 from memory, direct user input, or from outside of the device such as via a data port or network. Next, at 406, an appropriate pixel matrix is calculated from the image data. This pixel matrix is used to generate a corresponding set of control codes for array control at 408. Such control codes suitably dictate which elements to enable, and optionally the duration or active periods for such elements at 410. The particular codes are used to fire the appropriate elements to achieve a desired effect on the food. While FIG. 4 illustrates heater elements, it will be appreciated that the disclosed system is suitably applied to application of colorants by applicators as detailed above.

Next, at 412 the process is either continued, if imaging is not completed, or the foodstuff is ejected at 414 if completed. The process then suitably concludes at 416.

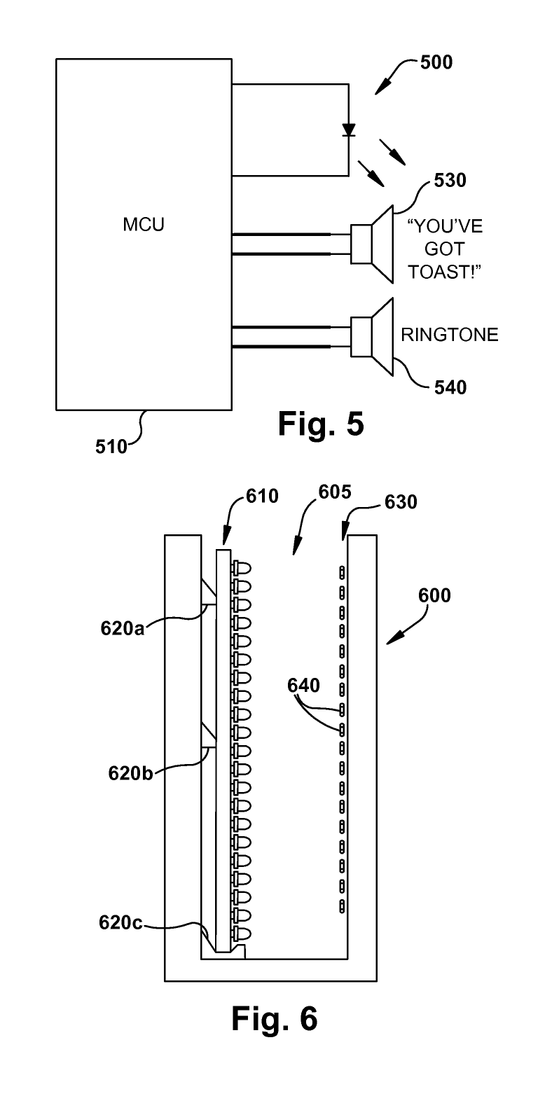

Turning now to FIG. 5, illustrated is an example embodiment when the system detailed above includes a visible or audible indicator. Such an indicator is suitably generated at one or more stages in connection with operation of the device. By way of example, indicate events suitably include when a device is prepared to receive or output an image, when the image is being applied, or when the imaging operation is complete. By way of further example, a lamp or other visible indicator, such as light emitting diode provides a suitable indicator. Different colors, flash patterns or multiple light emitters are suitably implemented to provide one or more of the indicated events as noted above. Alternatively, or in addition to, visible indication is an audible output such as via an audio transducer, such as that illustrated by speakers 530 or 540. In the illustration, speaker 530 suitably outputs an audible indicator, such as a verbal message, music, tones, or any other suitable sound output. Speaker 540 suitably outputs preset, random or selected ringtones. By way of further example, a unique indicator suitably exists for different people and images corresponding to each. In another example embodiment, an indicator is suitably communicated to another device associated with a user, such as a cell phone call, text message or e-mail.

Turning now to FIG. 6, illustrated is an example embodiment wherein an image applicator 600 suitably realized as a toaster is illustrated in a cut-away view. An interior 605 is operable to receive a slice of bread, or other foodstuff amenable to image deposition. In the illustrated embodiment, application of an image is suitably realized by an array 610 of diodes. While the illustration includes a rectangular, generally planar array, it will be appreciated that any suitable orientation may be used in accordance with a particular application. The illustrated embodiment further includes brackets 620, comprised of bracket portions 620a, 620b and 620c. Use of any suitable bracket further allows for replacement of a particular applicator, such as one using heat, with another applicator, such as one that colorizes with dye.

Also illustrated in FIG. 6 is an array for applying heat to an opposite side of food item. In an example embodiment, imaging is provided on one side of bread during a toasting process while heating or toasting is applied across an exterior surface of the other side. Heating is suitably provided by an array 630. The array 630 is suitably comprised of conventional heating elements such as that illustrated at 640. It will be appreciated that alternative embodiments suitably replicate an image application array on both sides. In another embodiment, heating elements 640 are comprised of LEDs, such as laser LEDs, to provide controlled, improved or more uniform exposure of an opposed side of a substrate such as bread. As will be appreciated from the further description below, heating elements need not be fixed across an entire surface of a food item. A single element, or a smaller grouping of elements, are suitably moved horizontally, vertically, or in both directions, during the heating or imaging process.

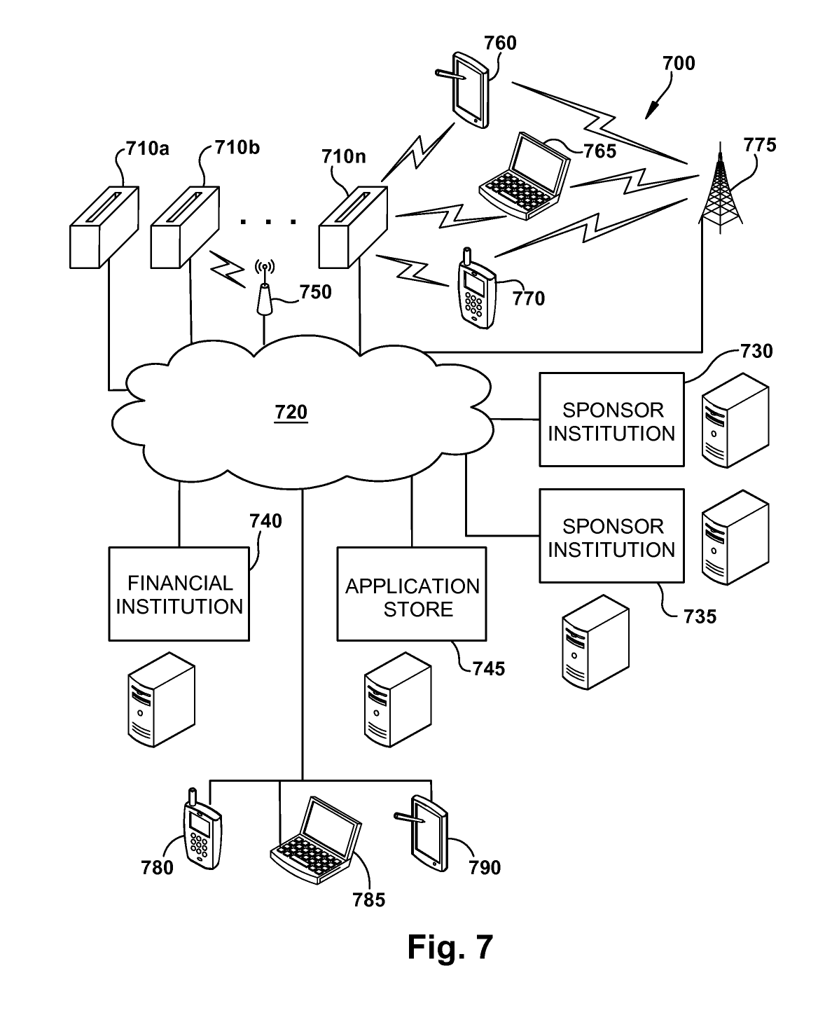

Referring next to FIG. 7, illustrated is a networked system 700 as an example embodiment suitable for implementation of a food imaging system in a commercial or sponsored message environment. In the illustrated embodiment, one or more image application systems 710, illustrated as toasters 710a, 710b, . . . , 710n, are in data communication with a common network 720, suitably the Internet, a local area network, a wide area network or a combination thereof. Also in data communication with network 720 are one or more sponsor institutions such as those illustrated at 730 and 735. As will be appreciated with the additional description below, sponsor institutions are suitably comprised as an entity that desires to take advantage of a food labeling system. Such a sponsoring entity may suitably provide consideration to a messaging service or image repository such as application store 745, or an end user, for the ability to provide desired images. Remuneration is suitably accomplished by use of a networked financial institution such as that illustrated at 740. Any suitable payment scheme is suitably implemented, such as via banks, services such as PayPal, or Bitcoin. Alternatively, coupons or other consideration are suitably implemented.

Also illustrated in FIG. 7 are example embodiments of various data exchange options relative to an imaging device and other digital devices. Illustrated in connection with toaster 710b is a wireless data path to the network 720 via an access point 750. Any suitable data connection is contemplated, including WiFi, Bluetooth, wireless USB, optical, near field, and the like. Illustrated, by way of further example, in data connection with 710n are alternative, direct connections to other devices, such as tablet 760, computer 765 and smart phone 770. It will be appreciated that any suitable data connection, such as those noted above, is suitable. Data connection is also suitably completed via a telephonic link such as that illustrated with telephone access point 775. It will be appreciated that a wired connection to other devices, via network 720, provides a data path to devices such as smartphone 780, computer 785 or tablet 790.

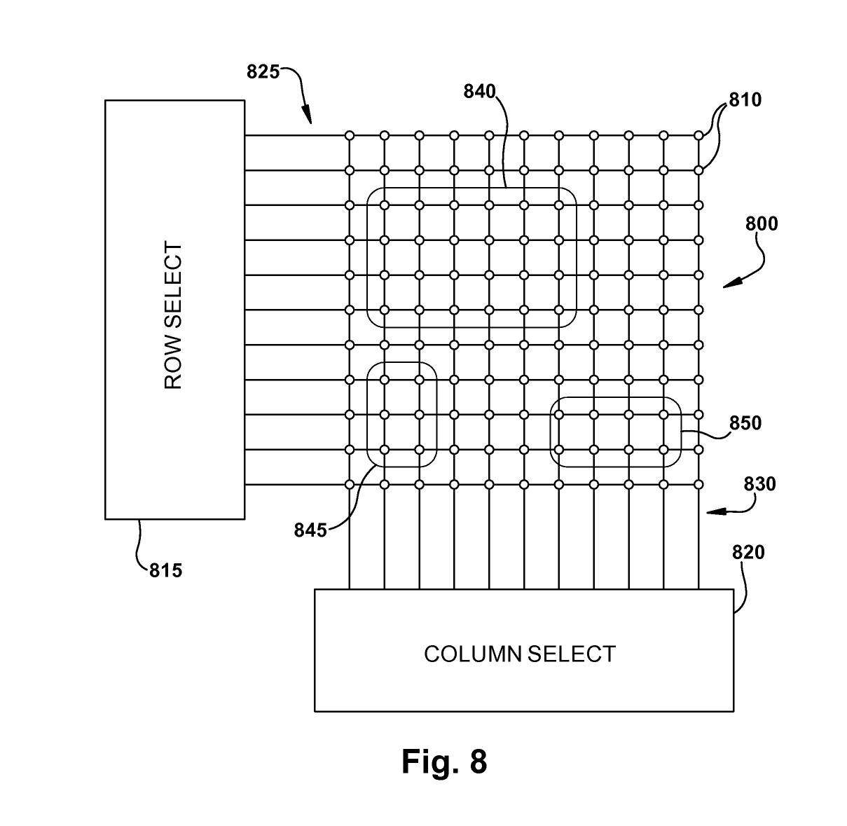

Turning to FIG. 8, illustrated is an example embodiment of a heating element array 800, suitably configured as a rectangular array of light emitting diodes, such as laser diodes. In the illustrated embodiment, the array is comprised of heating elements 810. A row select 815 and a column select 820 each have a series of row conductors 825 and column conductors 830, respectively. Selection is enabled to provide a voltage on one or more conductors emanating therefrom. Selective powering of wires by row select 815 and/or column select 820 facilitates selection of one or more array areas for selective enablement of associated heating elements. By way of further example, area 840, area 845 or area 850 are selectively enabled, individually or together, by enabling rows and columns that intersect the desired area.

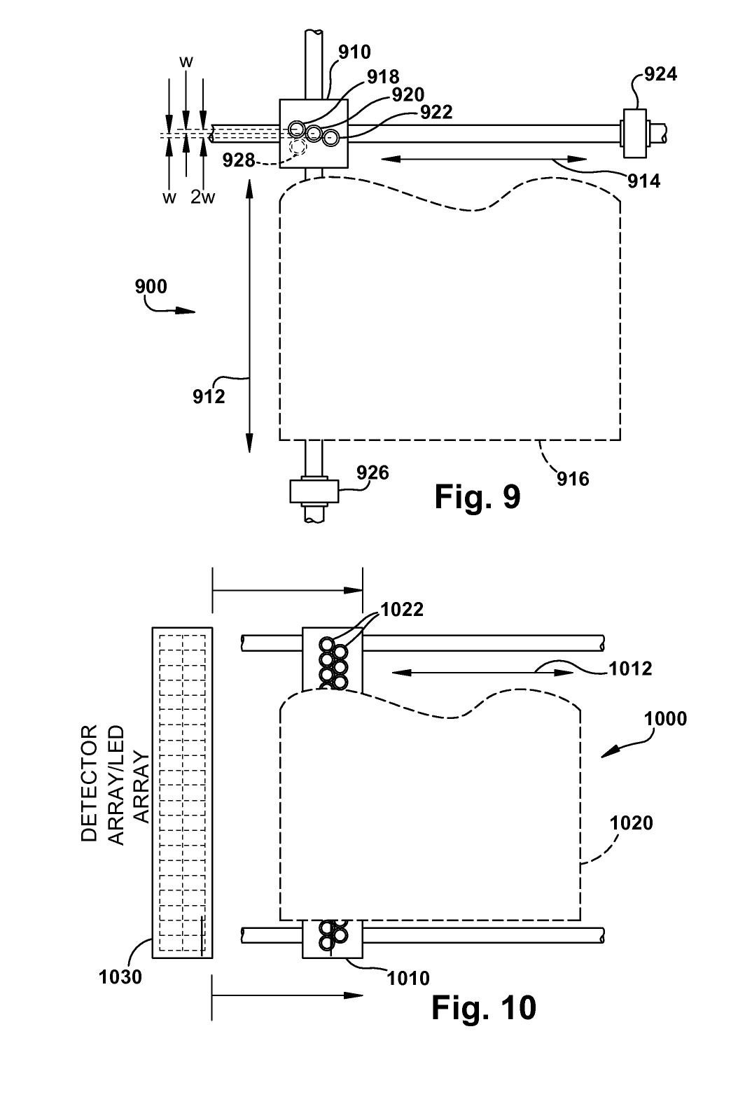

Referring next to FIG. 9, illustrated is an example embodiment of an image application mechanism 900 that includes a lighting element 910 that is moveable in complementary axes 912 and 914. The lighting element 910 is moveable relative to a surface area of a food article 916, illustrated as a bread slice. The lighting element 910 suitably includes laser LED output from one or more solid state laser devices. In the illustration, three LED lasers 918, 920, and 922. While three LEDs are in the illustrated embodiment, it will be appreciated that any number of elements are suitable. An advantage of multiple LEDs arranged analogously to the illustrated embodiment is relative to additional resolution for imaging. When LEDs are arranged in a direction parallel to a direction of travel of the array 910, maximum resolution of an image is dependent on how closely they can be placed relative to one another. Orienting LEDs at an angle to one or more directions of travel affords increased resolution capability. In the illustration, LEDs 918, 920, and 922 are angled relative to axes 912 and 914. In the illustration, relative distance between operative LED elements is effectively reduced relative to if they were aligned perpendicular to the axis of travel as illustrated with LED 930. As the lighting element moves along a surface of the bread slice 916, different LEDs are suitably activate at different times. This results in hot spots on the bread at relatively close proximity. Distance between hot spots is reduced to w, as illustrated in FIG. 9. LED enablement is suitably controlled by the MCU via software so as to generate a high resolution image as the lighting element is moved along the surface of bread slice 916 or other suitable food article.

In the illustration of FIG. 9, movement along axis 912 or 914 is suitably accomplished by a mechanical transducer such as that illustrated at 924 and 926. Suitable movement is accomplished in accordance with any suitable drive mechanism, including but not limited to screw drives, worm gears, drive belts, pistons, rack-and-pinion gearing, solenoids, or voice coils as will be appreciated by one of ordinary skill in the art.

Referring next to FIG. 10, illustrated is an example embodiment of an image application mechanism 1000 that includes a lighting element 1010 that is moveable along a single axis 1012. The lighting element 1010 is advantageously sized to correspond to a dimension of a food article such as a bread slice 1020. Lighting element 1010 is suitably comprised of a linear array of lighting elements sufficient to traverse the food article in one dimension while the array is enabled for travel across a surface of the food article in a complementary dimension. In the illustration, laser LEDs 1022 are illustrated as an example embodiment. The LEDs 1022 are arranged in one or more rows, suitably staggered for increased resolution as depicted in the figure in a manner such as that detailed in connection with FIG. 9, above.

The illustration of FIG. 10 illustrates another example embodiment of an image application mechanism 1000 wherein a complementary array 1030 is suitably fixed in a moveable manner across from lighting element 1010 on a complementary side of the food article. The array 1030 is suitably comprised of photodetectors, photodiodes, or a combination thereof. It will be appreciated that photodiodes have an inherent capability to serve as photodetectors. While a typical photodiode will not have the resolution or sensitivity of a dedicated photodetector, the capabilities are suitable for use in connection with embodiments disclosed herein. Use of photodiodes and/or photodetectors affords functionality of heating the complementary food surface concurrently with heating of the other side. Image application may also suitably be accomplished on the complementary side when the photodiodes are enabled analogously to those in array 1010.

Sizing of a food article is suitably accomplished by sensing light that propagates between arrays by any suitable mechanism as noted above.

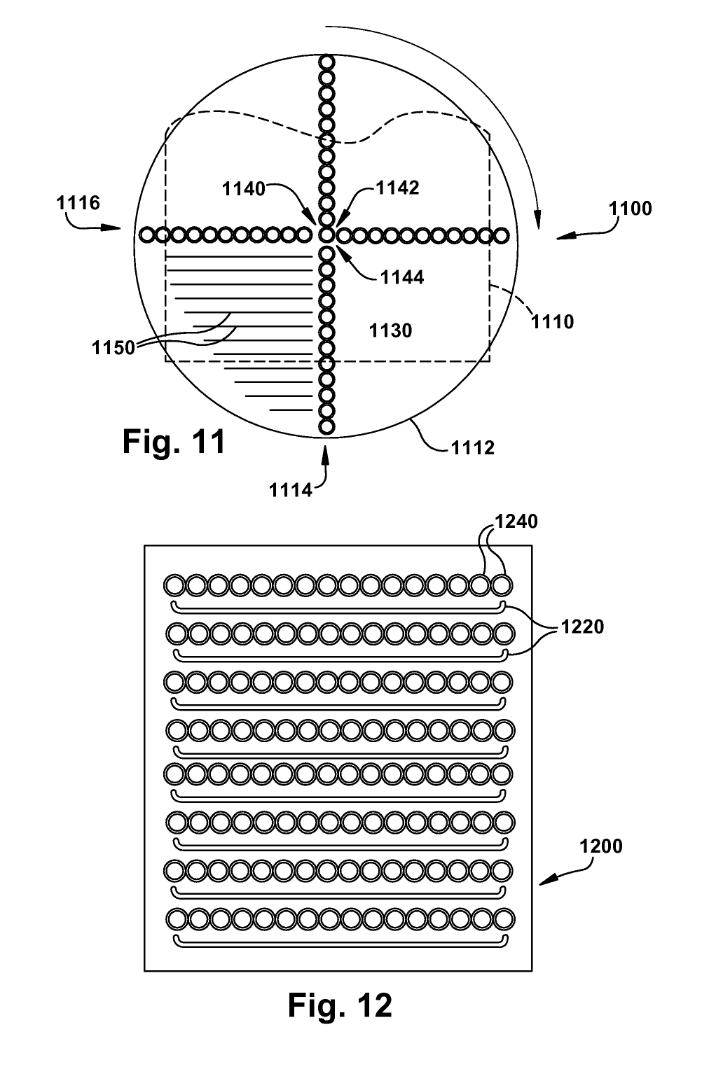

Turning next to FIG. 11, illustrated is another example embodiment of an image application mechanism 1100 operable to rotate relative to a surface of a food article such as that illustrated by bread slice 1110. A rotatable surface 1112 suitably includes one or more arrays of heating elements such as those illustrated at 1114 and 1116. It will be appreciated that the one or more arrays are suitable oriented an any suitable fashion. As noted above, selective enablement of one or more elements, such as laser LEDs 1130 facilitates heating of a food surface as well as adding indicia. In the illustrated embodiment, different radial displacement of LEDs, such as that indicated by varying gaps 1140, 1142 and 1144 facilitates increased resolution when LEDs are selectively enabled relative to rotation analogously to the embodiments detailed above.

Also illustrated in FIG. 11 are conventional heating elements 1150, suitably comprised of resistive wire or any other suitable element. While an entire surface of a food item is suitably accomplished by elements such as laser LEDs, inclusion of conventional heating elements facilitates concurrent heating of the surface for uniform application such as toasting of a bread slice across its surface.

FIG. 12 illustrates another example embodiment of a heating and imaging array 1200 suitably comprised of complementary conventional heating elements 1220 and LED heating elements 1240. Relative arrangement is in any suitable manner, including in connection with the embodiments detailed above.

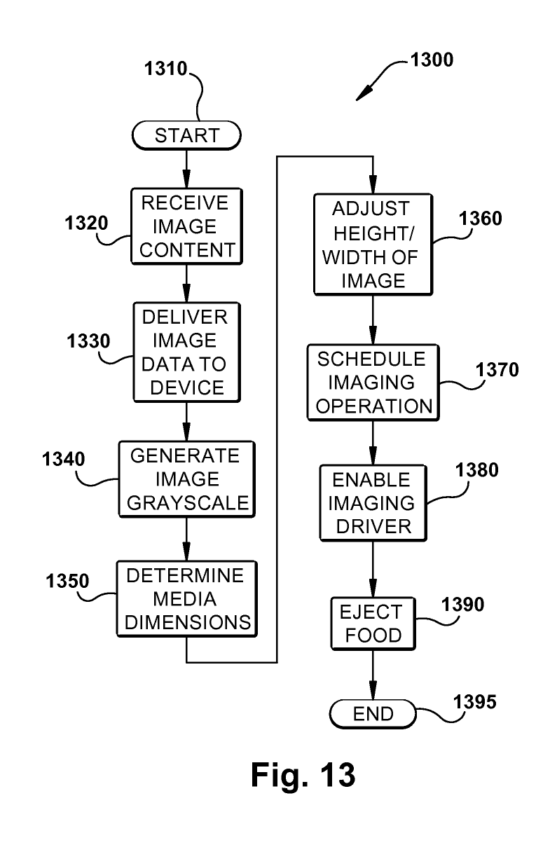

FIG. 13 illustrates an example embodiment of a suitable control routine 1300, suitably contained in whole or in part as a software routine operable in conjunction with a CPU or microcontroller as detailed above. In the illustrated example, the process commences at 1310 and proceeds to 1320 wherein suitable image content is acquired. Image content is suitably in any form, including bitmapped, vector-based or encoded images. By way of example, representative formats suitably include JPEG images, PDF files, GIF files, DXF files, Visio files, XPS files, printer files, DWG files, BMP files, etc. Content is suitably received by any wireless, optical or wired data connection as detailed above. Image data is delivered to the imaging device at 1330. A grayscale image is generated for the image file at 1340. Size information, suitably determined in connection with the embodiments detailed above, is determined at block 1350 and applied at block 1360 to scale an image in accordance with a size of a food article and image application capabilities of a device. Scheduling of the imaging operation occurs at 1370. An imaging driver is enabled and controlled at 1380. Once an imaging and/or heating operation is completed, the food article is suitably ejected at 1390 and the process suitably ends at 1395. It will be appreciated that not every step need be completed in every situation. By way of example, predefined image data may already be scaled or fixed for a specific application, or image data may already be stored as grayscale information in a format ready for control of the imaging device.

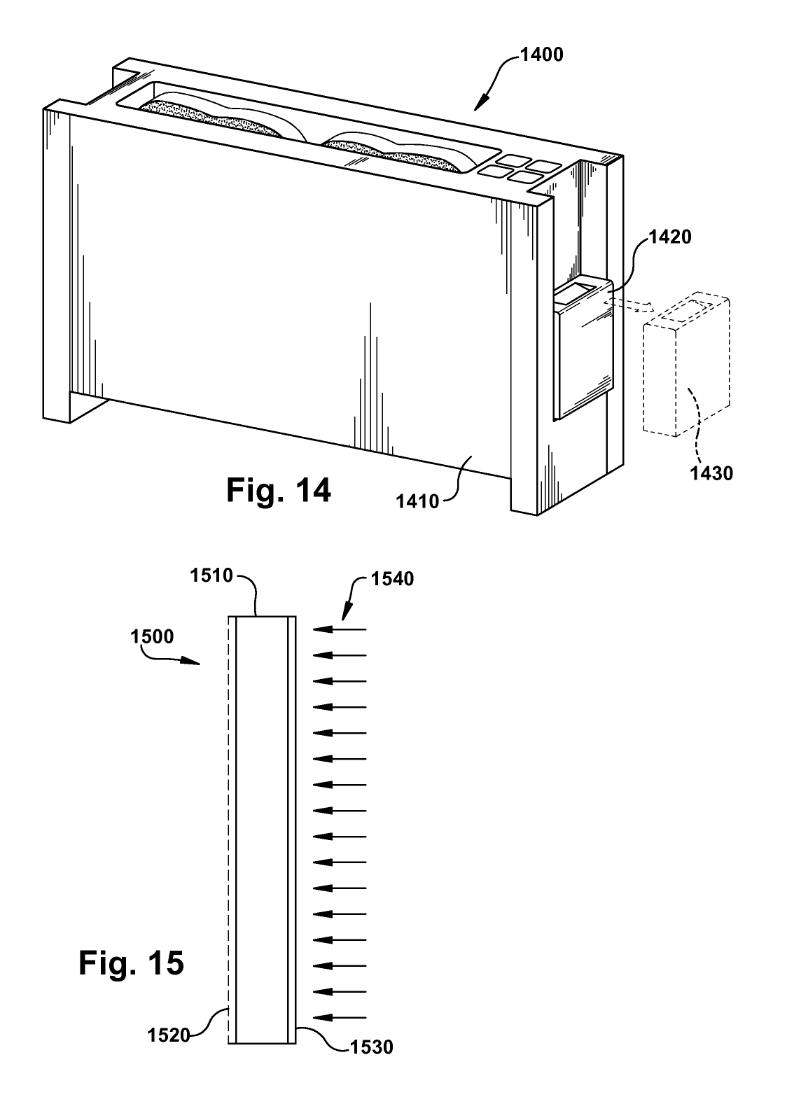

FIG. 14 illustrates an example embodiment of an imaging device 1400, suitably provided with functionality in one or more of the embodiments noted above. In the illustrated embodiment, a base unit 1401 is associated with a module 1420, suitably provided with selected components noted above. Provision of some or all of control or data interface functionality in a separate module affords an option to selectively provide additional functionality. In the illustration, module 1420 is in the attached position and illustrated in a detached position in 1430.

By way of example, a relatively inexpensive base unit includes functionality to warm or cook one or more food items. Given relatively limited capabilities, such a base unit can be manufactured and sold at a relatively low cost. If a user desires additional functionality, such as imaging capability, enhanced imaging capability, data connection or connections, or enhanced cooking functionality, the user suitably obtains and attaches a module having desired functionality. Thus, users who do not need such added capabilities are not burdened with extra cost. However, a module can be obtained and added at a point when such additional capabilities are desired.

Turning to FIG. 15, illustrated is example embodiment 1500 relative to image application on a non-food substrate. A substrate 1510 is any suitable imaging base platform material such as ceramic, glass, metal, wood, or the like that includes properties compatible with application image applying radiation such as heat, light or a combination thereof. Substrate 1510 is suitably heat and/or light sensitive, in whole or in part. In one example embodiment, the entire substrate is amenable to image application. In another example embodiment, some or all of one or more surface is associated with a film, coating or other radiation-sensitive material 1520, 1530. The substrate or other surface material is suitably reactive to form grayscale renderings. In still another example embodiment, a suitable material allows for variations in coloration or grayscale intensity in accordance with selective application of radiation 1540 so as to allow for colorized or sepia renderings.

By way of further example, suitable art for application in any embodiment noted herein is further available for online repositories such as shutterstock.com. American Greetings, Pinterest, Tumblr, Facebook, Twitter, Snapchat, etc.

While any image, text or combination is suitably realized in conjunction with the capabilities and resolution of a chosen array or applicator, the controllability and MCU controlled application system facilitates generation of many images, including:

daily appointments from your calendar;

greetings;

reminders;

celebration of events or seasons;

birthday/anniversary etc. wishes;

advertising or branding;

specialized or hybrid advertising as part of a scheme whereby images are produced on the substrate in conjunction with a coupon that is sent to the imaging device;

images produced on the substrate as part of a sweepstakes;

weather, news, headlines;

humor; or

images that promote a movie, event, product, service or such some other similar situation.

In an embodiment when the device is associated with a network, such as the Internet, various images or messages, or other content is suitably remotely generated and applied, such as with sponsored advertising, greetings or text messages.

The device suitably includes an option for timed defined or delayed start, so that, for instance, a parent could load the image with the start time to correspond to the time that their child would be eating breakfast.

The subject device is further conducive to operation in conjunction with a website for uploading and subsequent downloading of images to be used with the device. Packaging of various images for bulk downloading are also suitably implemented. Individuals/groups/automated devices suitably upload images for subsequent, optional receipt of remuneration when the image is downloaded.

A site suitably allows third parties to sponsor contests to bring attention to their products or events. This might be in conjunction with prizes for downloading and producing the image on a substrate. Or by sponsoring the site or by advertising on the site or receiving information on the site.

A site also suitably allows for friends to send each other images that are printed by surprise to the recipient. Third parties may be allowed to send images directly to the device in return for information, remuneration, or benefit due to the downloading or generation of an image or multiple images on the substrate.

In addition to the forgoing, it will be appreciated that a specialized food substrate (bread, pancake, or otherwise) is suitably implemented. By way of example, specialized foods may be provided with minimal holes or pores so as to be relatively smooth, allowing for finer gradation of the image through either heat, lack of heat, color or lack of color or other such image generating schemes.

Specialized substrate are also suitably provided with a tab, specialized shape, conduction properties or other signaling device recognized by the imaging element device thereby signaling to the device that the substrate being used is approved for use by the device.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

It is claimed:

1. An apparatus comprising:
a support operable to receive an associated food item;
a processor;
a data storage in data communication with the processor;
an image generator operable to output image data associated with an image retrieved from the data storage in accordance with operation of the processor;
a heating element disposed proximate to the support; and
the heating element operable to apply heat to selected areas of a surface of the associated food item so as to imprint the a visual rendering defined by the image data.

2. The apparatus of claim 1 wherein the heating element is comprised of an array of independently operable point sources directed toward the associated food item.

3. The apparatus of claim 2 further comprising a transducer operable to move the array in at least one dimension along the surface to form the imprint.

4. The apparatus of claim 3 further comprising a transducer operable to move the array in at least a second dimension along the surface to form the imprint.

5. The apparatus of claim 1 wherein the heating element is comprised of at least one laser diode.

6. The apparatus of claim 5 wherein the heating element is comprised of a plurality of laser diodes.

7. The apparatus of claim 6 further comprising:
the plurality of laser diodes formed in array; and
a transducer operable to move the array in at least one dimension along the surface to form the imprint.

8. The apparatus of claim 6 wherein at least a portion of the diodes in the array are oriented relative to one another such that a portion of at least one diode leading surface relative to movement in the at least one dimension is partially covered by another diode of the array

9. A method comprising:
receiving a food item into an imaging device;
retrieving image data representative of an image from an associated data storage in accordance with operation of a processor; and
selectively enabling a plurality of heating elements disposed proximate to a surface of the food item to heat portions of the surface to render the image thereon.

10. The method of claim 9 further comprising moving the heating elements relative to the surface while selectively enabling the heating elements.

11. The method of claim 9 further comprising selectively enabling the heating elements by selectively powering laser diodes directed to the surface.

12. The method of claim 9 further comprising receiving the image data via a data connection with an associated computer.

13. The method of claim 12 further comprising retrieving the image data from an image repository in data communication with the imaging device via a data network.

14. The method of claim 12 further comprising:
receiving an image order from an associated user via the network;
assessing a fee to the associated user in accordance with the image order;
retrieving the image data from the repository in accordance with the image order.

15. An apparatus comprising:
a support operable to receive an associated food item;
a processor;
a data storage in data communication with the processor;
an array of laser diodes directed to apply heat to at least one surface of the associated food item when received in the support;
an array controller operable to enable the array of laser diodes in accordance with an output of the processor;
a data connector operable to selectively receive an associated data processing device in data communication with the processor; and
the data connector including at least one data input operable to receive control data operable to selectively control discrete portions of laser diodes in the array during application of heat to the at least one surface.

16. The apparatus of claim 15 further comprising a module coupled to the data connector, the module including:
an image generator operable to process image data associated with an image retrieved from an associated data storage;
an output operable to generate the control data in accordance with the image data so as to generate on the at least one surface a visual rendering corresponding to the image data.
the heating element operable to apply heat to selected areas of a surface of the associated food item so as to imprint the a visual rendering defined by the image data.

17. The apparatus of claim 16 further comprising a network interface operable to receive the image data.

18. The apparatus of claim 17 wherein the network interface is operable to receive the image data from an associated networked server.

19. The apparatus of claim 18 further comprising a transducer operable to move the array in at least one dimension relative to the at least one surface to generate to visual rendering.

19. The apparatus of claim 15 further comprising at least one resistive heating element operable to apply heat to the associated food item.
